(19) United States
(12) Patent Application Publication
(10) Pub. No.: US 2022/0201505 A1
(43) Pub. Date: Jun. 23, 2022

(54) METHODS FOR ENABLING BEAM REFERENCE SIGNALLING, WIRELESS DEVICES AND NETWORK NODES

(71) Applicant: Sony Group Corporation, Tokyo (JP)

(72) Inventors: Kun ZHAO, Malmö (SE); Fredrik RUSEK, Eslöv (SE); Erik BENGTSSON, Lund (SE); Olof ZANDER, Lund (SE)

(21) Appl. No.: 17/602,043

(22) PCT Filed: Mar. 26, 2020
(86) PCT No.: PCT/EP2020/058521

§ 371 Date: Oct. 7, 2021

(30) Foreign Application Priority Data
Apr. 30, 2019 (SE) 1950519-7

(51) Int. Cl. H04W 16/28; H04L 5/00; H04W 52/36

(52) U.S. Cl. CPC H04W 16/28; H04W 52/367; H04L 5/0048

(57) ABSTRACT

A method, performed by a network node, for beam reference signaling, is disclosed. The network node is configured to communicate, using a set of beams, with a wireless device of a wireless communication system. The method comprising transmitting one or more first downlink, DL, beam reference signals to the wireless device; and receiving, from the wireless device, control signaling indicative of a need for altering downlink beam reference signaling.

The present disclosure relates to the field of wireless communications. The present disclosure relates to methods for enabling beam reference signaling, related network nodes, and related wireless devices.

### BACKGROUND

In 5G New Radio (NR) wireless communication systems, a wireless device (for example, a user equipment, UE) may both receive and transmit signals. In both cases, the wireless device may receive and/or transmit in specified physical directions, and the directions may be found by the wireless device. To facilitate finding the receive direction, in NR, a network node (for example, a base station, or a gNB) transmits reference symbols or reference signals (RS) to the wireless device, which may allow the wireless device to test different receive directions by measuring the downlink reference signals and then select the best one (for example, the one with most incoming power).

Due to dynamic changes of wireless channels in real life, and due to hardware issues, it may be difficult for a wireless device to guarantee beam correspondence (BC) all the time based on current wireless device capability signaling of BC.

Relying solely on the downlink measurements is not sufficient to select appropriately one or more uplink beams. Relying on uplink beam sweeping is typically also sub-optimal due to the delay that it creates and due to limited Sounding Reference Signal (SRS) resources that the network node is capable of configuring.

### SUMMARY

Accordingly, there is a need for methods, wireless devices and network nodes, which mitigate, alleviate or address the shortcomings existing and provides an improved beam reference signaling that permits to indicate the wireless device's need for altering the beam reference signaling (e.g. modifying the beam reference signaling for adaptation or enhancement).

A method for beam reference signaling is disclosed. The method is performed by a network node. The network node is configured to communicate with a wireless device of a wireless communication system. The method comprises transmitting one or more first downlink, DL, beam reference signals to the wireless device. The method comprises receiving, from the wireless device, control signaling indicative of a need for altering downlink beam reference signaling (such as for beam correspondence).

Further, a network node is provided. The network node comprises a memory, a processor, and an interface. The network node is configured to perform any of the methods disclosed herein.

Thereby, the network node can alter the downlink beam reference signaling in response to receiving the disclosed signaling indicative of a need for altering the downlink beam reference signaling, which may lead to beam correspondence.

A method for beam reference signaling is disclosed. The method is performed by a wireless device. The wireless device is configured to communicate, using a set of beams, with a network node of a wireless communication system. The method comprises determining an inability to establish beam correspondence. The method comprises transmitting, in response to the determining, control signaling indicative of a need for altering DL beam reference signaling for beam correspondence.

Further, a wireless device is provided. The wireless device comprises a memory, a processor, and a wireless interface. The wireless device is configured to perform any of the methods disclosed herein.

Thereby, the wireless device can indicate a need for altering the downlink beam reference signaling when the wireless device determines that beam correspondence cannot be established for the current uplink beam. Thus, the wireless device may obtain beam correspondence by e.g. receiving appropriate or adjusted DL beam reference signaling from the network node.

The disclosure provides in one or more embodiments an improvement of the selection of a beam (such as an uplink, UL, beam) by the wireless device and eventually an improvement of the performance of the uplink communication established using beam correspondence in situations when it is otherwise difficult for the wireless device to determine an appropriate transmission beam due to the conditions related to the communication channel, and/or the wireless device hardware.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1A is a diagram illustrating an example wireless communication system comprising an exemplary network node and an exemplary wireless device according to this disclosure,

FIG. 1B illustrates two example graphs illustrating RSRP accuracy vs. Signal to Noise Ratio (SNR) and illustrating RSRP accuracy vs. DL RS configuration, respectively.

FIG. 1C illustrates two example graphs illustrating uplink beam spherical coverage with different measurement accuracy (error) of downlink RSRP for autonomously chosen uplink beams, and illustrating uplink spherical coverage with different Sounding Reference Signal (SRS) resources for uplink beam sweeping, respectively.

FIG. 2 is a flow-chart illustrating an example method, performed by a network node, for beam reference signaling according to this disclosure,

FIG. 3 is a flow-chart illustrating an example method, performed by a wireless device, for beam reference signaling according to this disclosure,

FIG. 4 is a block diagram illustrating an exemplary wireless device according to this disclosure, and

FIG. 5 is a block diagram illustrating an exemplary network node according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

When a wireless device may select an uplink beam for transmission to a network node autonomously based on a downlink reference signal (DL RS) from the network node, 3rd Generation Partnership Project (3GPP) defines that beam correspondence (BC) holds.

The 3^{rd} Generation Partnership Project, 3GPP, systems are to operate with Tx/Rx beam correspondence at the network node (e.g. gNB, and/or Transmission Reception point, TRP) and the wireless device, so called UE, according to the following rules. Tx/Rx beam correspondence at TRP holds if at least one of the following is satisfied:
TRP is able to determine a TRP Rx beam for the uplink reception based on UE's downlink measurement on TRP's one or more Tx beams.
TRP is able to determine a TRP Tx beam for the downlink transmission based on TRP's uplink measurement on TRP's one or more Rx beams

Tx/Rx beam correspondence at UE holds if at least one of the following is satisfied:
UE is able to determine a UE Tx beam for the uplink transmission based on UE's downlink measurement on UE's one or more Rx beams.
UE is able to determine a UE Rx beam for the downlink reception based on TRP's indication based on uplink measurement on UE's one or more Tx beams.

The 3^{rd} Generation Partnership Project, 3GPP, system provides that beam correspondence is mandatory with the capability signaling definition as follows. For example, a UE that fulfils the beam correspondence requirement without the uplink beam sweeping is to set the BC capability bit to 1. For example, a UE or wireless device that fulfils the beam correspondence requirement with the uplink beam sweeping is to set the BC capability bit to 0.

At the wireless device, DL beam corresponds to an Rx beam while an UL beam corresponds to a Tx beam.

Beam correspondence may be seen as the ability of the UE to select a suitable beam for UL transmission based on DL measurements with or without relying on UL beam sweeping. Stated differently, it may be seen as the ability of UE to choose the uplink beam autonomously based on DL measurements.

Measurement errors may influence the actual capability and performance of determining best beams. To overcome the measurements errors, a BC capability parameter is set to indicate that UL beam sweep is always needed (e.g. BC capability set to 0) in order to fulfil BC. This leads to an increased overhead which can be avoided by the disclosed technique.

The BC capability bit can be interpreted as providing a good BC performance versus a poor BC performance. There are several factors causing measurement errors affecting the performance of the communication and therefor affecting the ability to establish BC.

For example, the possibility of the wireless device choosing the most performant uplink beam is limited by the accuracy of DL RS measurement (or more precisely by the precision of L1 Reference Signal Received Power (L1-RSRP) in Release 16 (Rel-16). For example, the precision of L1-RSRP measurements may be affected by the multipath propagation in the channel, interference from the neighbouring cells, measurement period of the wireless device, DL RS configuration etc. Therefore, the wireless device may be unable to select a proper uplink beam autonomously in many situations.

When the wireless device is unable to select an uplink beam autonomously, there are two possible scenarios:
the network node may select the uplink beam from the wireless device by requesting the wireless device to perform uplink beam sweeping.
the wireless device tries to pick its uplink beam autonomously again.

In either case, it is unclear whether any of these two possible scenarios lead to any improvement. It may be difficult for the wireless device to determine when and how the wireless device may be set in a specific mode with autonomous selection of UL beam (e.g. DL based estimation mode) or in another mode with UL beam sweeping (e.g. UL beam sweep mode). In addition, the wireless device may have its preference and capability limitation on a certain choice; for example, the uplink beam sweeping procedure (or UL beam sweep mode) usually causes a severe delay in the communication. A wireless device may for example prefer to operate its uplink beam autonomously instead of going to uplink beam sweep mode due to delay impact.

When the wireless device sets the BC capability bit to 1, then the network node may know that the wireless device can find the most favourable transmit direction from the downlink beam reference signals that are transmitted from the network node.

When the wireless device sets the bit to 0, then the network node may know that the wireless device has difficulties finding the most favourable transmit direction from the downlink beam reference signals that are transmitted from the network node. Therefore, the wireless device may conduct an uplink beam sweep of its own, followed by the network node conducting measurements and reporting to the wireless device what the best direction is (for example, what the best beam is).

The wireless device may test its spherical coverage of Effective Isotropic Radiated Power (EIRP) in a mode where the wireless device autonomously chooses an uplink beam (beam correspondence, EIRP 1) and also in a mode with uplink beam sweeping (EIRP 2). The cumulative distribution function (CDF) of the difference between the two sets of EIRP values (EIRP 2−EIRP 1) at X% shall be within Y dB where X and Y may be obtained from table 6.6.4.2-1 in chapter 6.6.4.2 of 3GPP TS 38.101. This may give a measure of how good the UE is to autonomously select a beam. This may be seen as a tolerance requirement for the wireless device who needs UL beam sweeping to meet spherical coverage requirement, and needs to be tested with autonomous uplink beam selection. The tolerance for EIRP may be lower than certain level. For example, X may be in the range of 85% and Y in the range of 2-7 dB in some scenarios.

The present disclosure proposes in one or more embodiments that the wireless device indicates a need for altering the downlink beam reference signaling when the wireless device determines that beam correspondence cannot be established for the current conditions. This in turn may lead to the wireless device obtaining beam correspondence by e.g. receiving appropriate (for example with adjusted resources, adjusted power, and/or adjusted transmission parameters) DL beam reference signaling from the network node.

Beam reference signaling may be seen as signaling to indicate a configuration of beam reference signals, e.g. reference signal for beam measurement. For example, the resource allocation (time and/or frequency), repetition rate of UL and/or DL beams may be shared via the beam reference signaling. For example, beam reference signaling may be used to indicate that the DL reference signal is to be transmitted with shorter periodicity, and/or that the DL reference signal is to be transmitted with higher number of OFDM symbols, and/or that the DL reference signal is to be transmitted over different frequency band parts.

The figures are schematic and simplified for clarity, and they merely show details which aid understanding the disclosure, while other details have been left out. Throughout, the same reference numerals are used for identical or corresponding parts.

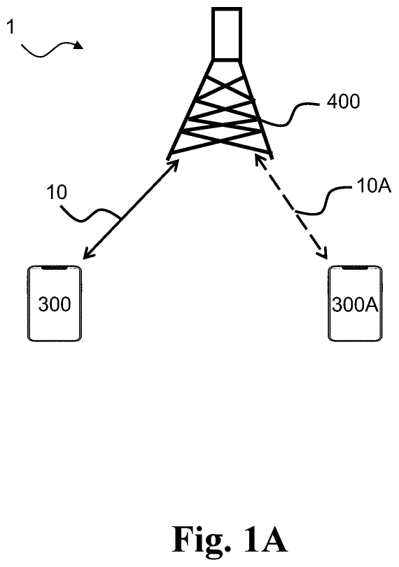

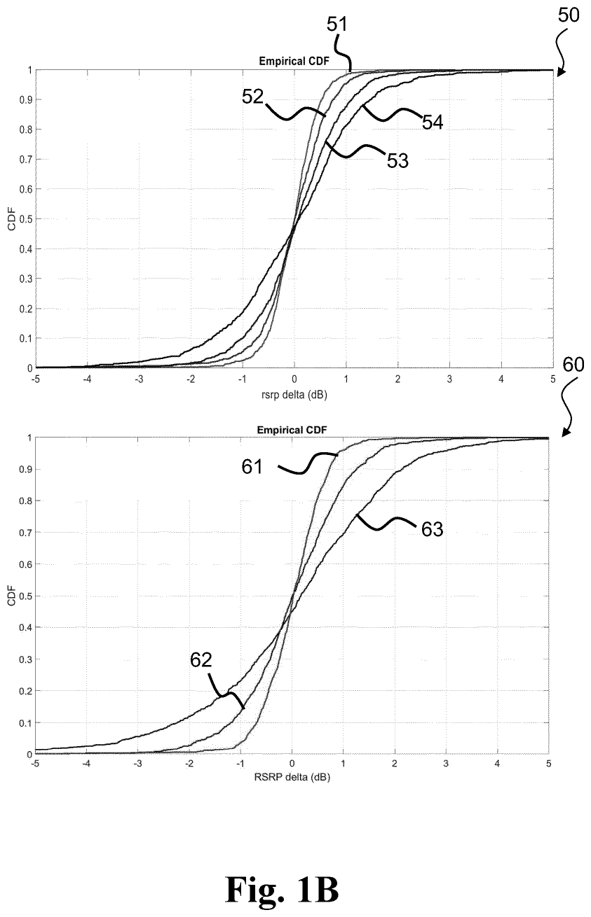

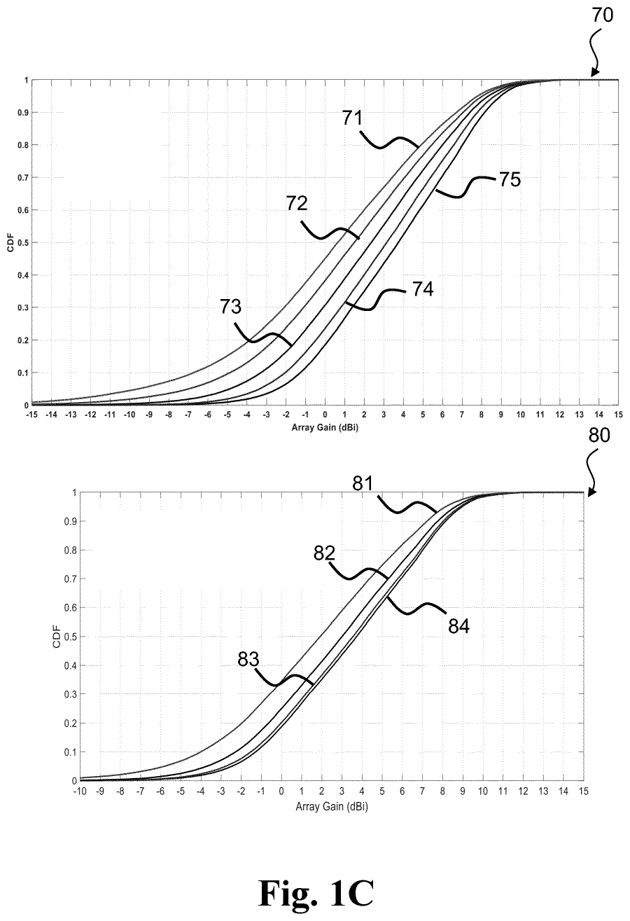

FIG. 1A is a diagram illustrating an example wireless communication system comprising an example network node and an example wireless device according to this disclosure.

As discussed in detail herein, the present disclosure relates to a wireless communication system 1 comprising a cellular system, e.g. a 3GPP wireless communication system, including e.g. millimetre wave communications. The wireless communication system 1 comprises a wireless device 300 and/or a network node 400. The wireless device 300 is configured to communicate with the network node 400.

The network node 400 disclosed herein refers to a radio network node, such as a radio access network node, operating in the radio access network, such as a base station, an evolved Node B (eNB), and/or a gNB.

The wireless communication system 1 described herein may comprise one or more wireless devices 300, 300A, and/or one or more network nodes 400, such as one or more of: a base station, an eNB, a gNB and/or an access point.

A network node may refer to an entity of a wireless network of a wireless communication system, used for establishing and controlling an air interface for communication with one or more wireless devices.

A wireless device may refer to one or more of: a mobile device a mobile or stationary computer, a tablet, a smart wearable device, and a smart phone device. In specifications under 3GPP, a wireless device is generally referred to as a user equipment (UE).

The wireless device 300, 300A may be configured to communicate with the network node 400 via a wireless link (or radio access link) 10, 10A. For example, the wireless device 300 is configured to determine a Tx beam for the uplink transmission based on downlink measurement on one or more Rx beams of the wireless device.

The wireless device 300 comprises a wireless interface comprising an antenna panel and optionally an additional antenna panel. An antenna panel may comprise one or more antenna elements, e.g. one or more antenna arrays.

FIG. 1B illustrates two example graphs with a first graph 50 illustrating RSRP accuracy vs. Signal to Noise Ratio (SNR) and a second graph 60 illustrating RSRP accuracy vs. DL RS configuration, respectively.

As discussed herein, a capability signaling may be used by the wireless device as an indication whether the wireless device needs uplink (UL) beam sweep. In realistic scenarios, the accuracy of the measurement on the DL reference signal (e.g., synchronization signal reference signal received power (SS-RSRP) or channel state information RSRP (CSI-RSRP)) depends on several factors, such as HW implementation of the measurement receiver of the wireless device, SNR of the DL synchronization signal, the interference situation seen by the wireless device, and the multipath propagation environment.

The first graph 50 illustrates CDF as a function of RSRP delta (for example RSRP error indicative of RSRP accuracy) measured in dB at four different SNR values. In a first curve 51, the SNR value is 6 dB. In a second curve 52, the SNR value is 3 dB. In a third curve 53, the SNR value is 0 dB. In a fourth curve 54, the SNR value is −3 dB.

The first graph 50 illustrates that the estimation error of RSRP is enlarged (increasing) with lower (decreasing) SNR. This may illustrate that, in some cases, the wireless device may estimate the transmit direction from the network node's reference signals, but in other cases, the wireless device cannot. Therefore, it is seen as sub-optimal to report a capability at initial access of the wireless device and to keep the capability fixed.

To further illustrate this finding, the second graph 60 illustrates CDF as a function of RSRP delta measured in dB with three different OFDM symbol configurations in DL reference signals (RS). In a first curve 61, there is a high number of subcarriers with a high number of OFDM symbols (e.g. larger than in a second curve 62, and a third curve 63). In a second curve 62, there is a low number of subcarriers with a high number of OFDM symbols. In a third curve 63, there is a low number of subcarriers with a low number of OFDM symbols.

In the second graph 60, the RSRP accuracy is compared with different OFDM symbol configuration in DL RS. It can be seen from graph 60 that increasing the resource on DL RS can improve the RSRP measurement accuracy, which may in turn improve the selection of a beam by the UE based on RSRP measurement.

FIG. 1C illustrates two example graphs with a third graph 70 illustrating uplink beam spherical coverage with different measurement accuracy (error) of downlink RSRP for autonomously chosen uplink beams, and a fourth graph 80 illustrating uplink spherical coverage with different Sounding Reference Signal (SRS) resources for uplink beam sweeping, respectively.

When a wireless device determines an uplink beam from measurements of downlink beam reference signals from a network node, the EIRP of the uplink beam from the wireless device in the desired direction is directly related to the accuracy of the measurement of the downlink beam reference signals.

In the third graph 70, the measurement error of RSRP of the downlink beam reference signals is modelled as a Gaussian distribution with a standard deviation, σ. The third graph 70 illustrates CDF as a function of Array Gain measured in dB at four different standard deviations (σ) and without error. In a first curve 71, σ is 8. In a second curve 72, σ is 6.In a third curve 73, σ is 4. In a fourth curve 74, σ is 2. A fifth curve 75 is without error.

It can be observed that the antenna gain in a desired direction (or EIRP in a real network) degrades with an increase in measurement error. Thereby, the wireless device's capability to estimate the transmit direction or transmit beam or UL beam may vary over time.

The fourth graph 80 illustrates uplink spherical coverage with different Sounding Reference Signal (SRS) resources for uplink beam sweeping (illustrating CDF as a function of Array Gain measured in dB) at three different values indicative of the number of SRS resources allocated and where no uplink beam sweeping is carried out.

For all four curves the RSRP error σ is 5. In a first curve 81, no uplink beam sweeping is carried out. In a second curve 82, the SRS value is 2. In a third curve 83, the SRS value is 4. In a fourth curve 84, the SRS value is 8.

When a wireless device reports that the BC capability bit is set to 0, this implies that an uplink beam sweeping is necessary, and the inventors have found that the performance becomes limited by the number of SRS resources that can be configured to the wireless device. For example, as shown in the fourth graph 80, the spherical coverage of the wireless device with uplink beam sweeping can be improved by allocating a higher number of SRS resources to the wireless device.

For example, the uplink performance of a wireless device can be improved by either improving the measurement accuracy of the downlink beam reference signal (for example, increasing the measurement sample or the measured symbols) or configuring more SRS resources. However, in either way, the time and overhead of the communication may be increased, and an unnecessarily high number of SRSs or an excessive DL measurement time may be needed. Therefore, the network node may need additional information to decide on an optimized solution to improve the wireless device uplink performance.

The present disclosure enables the network node to obtain the additional information to decide to alter or modify the DL beam reference signaling so as to enable the wireless device to achieve or obtain or sustain beam correspondence.

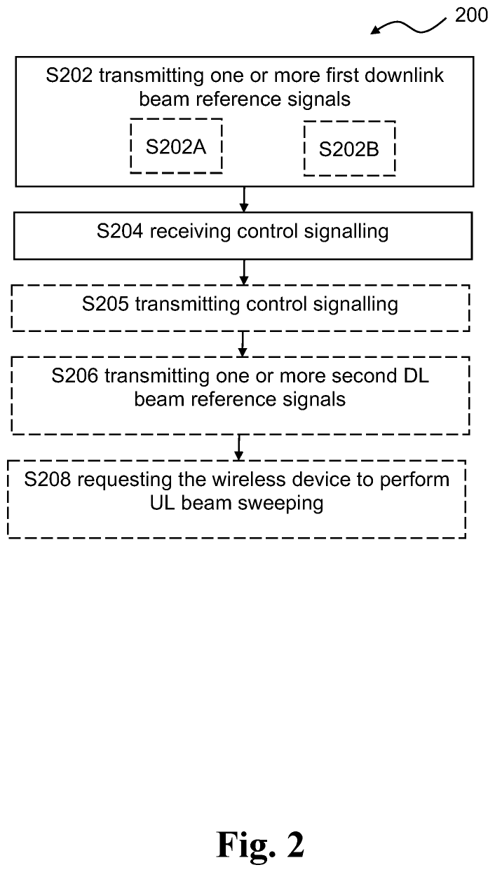

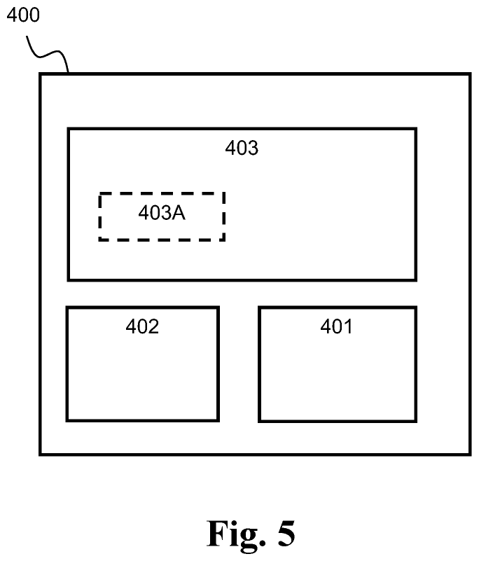

FIG. 2 is a flow-chart illustrating an example method 200, performed by a network node (e.g. the network node disclosed herein, such as network node 400 of FIGS. 1A and 5), for beam reference signaling according to this disclosure.

The network node is configured to communicate (optionally using a set of beams or an omnidirectional antenna), with a wireless device of a wireless communication system.

A beam disclosed herein may be seen as a spatial filter. In one or more example embodiments, an antenna circuitry of the network node may be configured to radiate a set of beams associated with a set of direction. An antenna circuitry of the wireless device may be configured to radiate a set of beams associated with a set of direction.

The method is for example performed when the wireless device is not able to select an UL beam based on DL measurements (due to interference, noise, hardware issues, etc.), and before the wireless device decides to fall back onto performing uplink beam sweeping which is time and power consuming. In the present disclosure, the wireless device indicates to the network node the need of altering the beam reference signaling. As illustrated herein, the network node may alter resource allocation, periodicity, power in the beam reference signals to support the wireless device in selecting autonomously the UL beam based on DL measurements.

The method 200 comprises transmitting S202 one or more first downlink, DL, beam reference signals to the wireless device. A beam reference signal is for example a reference signal received on a beam used for DL measurements by the wireless device to select one or more appropriate UL and/or DL beams (such as Tx beam(s) and/or Rx beam(s)).

For example, transmitting S202 the one or more first DL beam reference signals may comprise broadcasting the one or more first DL beam reference signals beam reference signal (e.g. using one or more synchronization signal block (SSB) signal). In one or more example methods, transmitting S202 one or more first DL beam reference signals to the wireless device comprises transmitting S202A, on one or more receive beams (Rx), the one or more first DL beam reference signals to the wireless device. In one or more example methods, transmitting S202 one or more first DL beam reference signals to the wireless device comprises broadcasting S202B, the one or more first DL beam reference signals.

The method 200 comprises receiving S204, from the wireless device, control signaling indicative of a need for altering DL beam reference signaling (such as for beam correspondence, so that the wireless device is capable of selecting autonomously the UL beam based on DL measurements.). For example, the control signaling may indicate that the wireless device needs a modification in the DL beam reference signaling to obtain beam correspondence autonomously. For example, the control signaling may be indicative of a request to modify the DL beam reference signaling. For example, the control signaling may be carried over one or more control signals from the wireless device to the network node. Altering DL beam reference signaling may comprise enhancing the beam reference signaling, and/or adjusting the beam reference signaling.

For example, the wireless device may transmit control signaling to the network node that indicates to the network node that the wireless device needs an altered DL beam reference signaling (for example, more DL RS resources) in order to autonomously select an uplink beam (to obtain beam correspondence) when the DL SNR (or signal to interference plus noise ratio (SINR)) is below a first threshold. The network node may take the RSRP, SNR (or SINR) and UE measurement period reported by the wireless device into account and configure an enhanced DL RS, or alternatively a degraded DL RS. There may be scenarios, where the beam reference signaling is adjusted so as to degrade, e.g. to reduce the resource allocation, to reduce the transmit power, due to for example the traffic in the cell observed by the network node.

For example, in realistic scenarios, the accuracy of the measurement on the DL beam reference signal (for example, Synchronization Signal Reference Signal Received Power (SS-RSRP) or CSI-RSRP) depends on several factors, such as the hardware implementation of the measurement receiver of the wireless device, SNR of the DL synchronization signal, the interference situation seen by the wireless device, and the multipath propagation environment.

In one or more example methods, the method 200 may comprise, upon one or more criterion being fulfilled, transmitting S206, based on the received control signaling, one or more second DL beam reference signals to the wireless device. In one or more example methods, the one or more second DL beam reference signals may differ from the one or more first DL beam reference signals. For example, the one or more criterion may be based on maximum power level of cell controlled by the network node or on resource allocation by the network node (for example, all resources have been used). For example, the one or more second DL beam reference signals may comprise an SSB signal. For example, the network node may configure the number of SRS based on the wireless device's capability on the maximum number of supported SRS resources, as well as the RSRP, SNR and/or SINR reported by the wireless device.

In one or more example methods, the one or more second DL beam reference signals may be partly the same as the one or more first DL beam reference signals.

In one or more example methods, the method 200 may comprise transmitting S205 control signaling indicative of altered DL beam reference signaling. In other words, the network node may indicate the altered DL beam reference signaling to the wireless device.

In one or more example methods, the control signaling indicative of a need for altering downlink beam reference signaling comprises control signaling indicative of a need for an additional downlink, DL, resource for beam reference signaling.

In one or more example methods, the control signaling indicative of the need for altering downlink beam reference signaling comprises control signaling indicative of a need for a modified power of the one or more DL beam reference signals.

In one or more example methods, the control signaling indicative of the need for altering downlink beam reference signaling comprises control signaling indicative of a need for a modified periodicity of transmission of the one or more DL beam reference signals. For example, a modified periodicity of transmission of the one or more DL beam reference signals may comprise a more frequently transmitted CSI-RS.

In one or more example methods, the control signaling indicative of the need for altering downlink beam reference signaling comprises control signaling indicative of a need for uplink beam sweeping. In one or more example methods, the method 200 may comprise requesting S208 the wireless device to perform uplink beam sweeping.

In one or more example methods, the one or more second DL beam reference signals may comprise one or more second DL beam reference signals with one or more of: a modified transmit power, an additional resource allocated, and a modified periodicity of transmission. For example, the one or more second DL beam reference signals may comprise an enhanced or degraded DL RS. For example, the one or more second DL beam reference signals may comprise a more frequently transmitted CSI-RS. For example, the one or more second DL beam reference signals may comprise a higher number in subcarrier in OFDM symbols for DL beam reference signals.

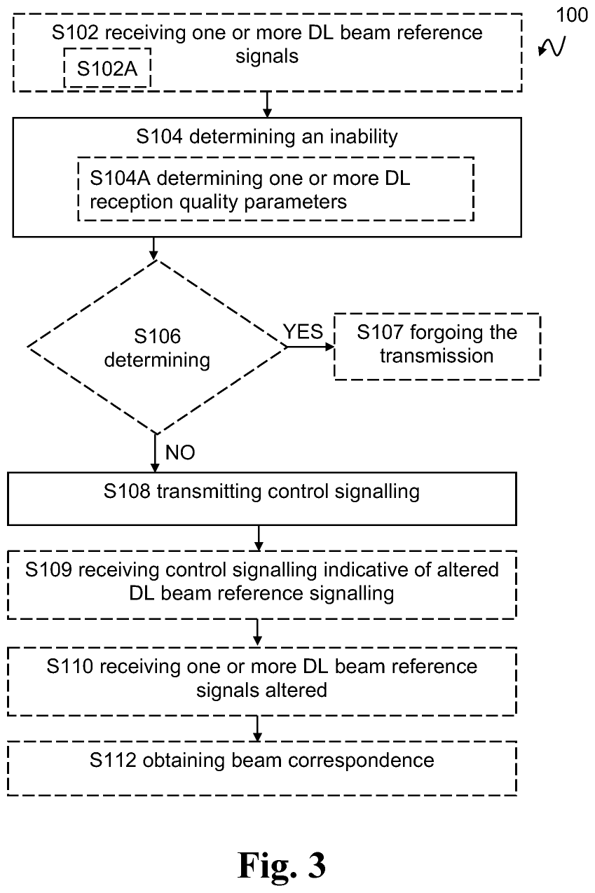

FIG. 3 is a flow-chart illustrating an example method 100, performed by a wireless device, for beam reference signaling according to this disclosure. For example, beam reference signaling may be seen as signaling indicating control of beam reference signals, for example reference signals for beam measurements.

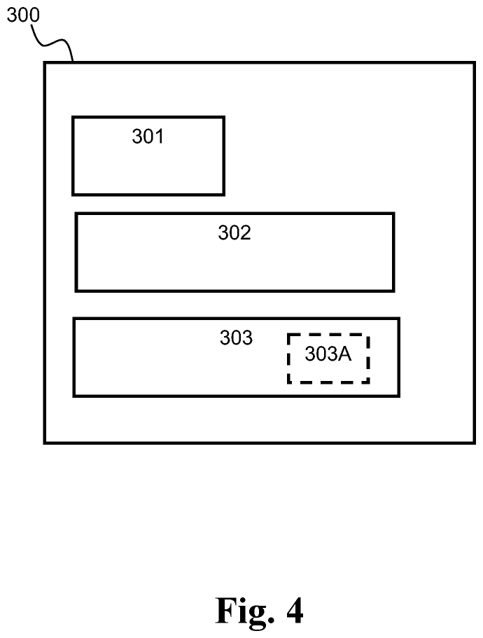

The method is performed by a wireless device (such as the wireless device disclosed herein, such as the wireless device 300 of FIGS. 1A and 4).

The wireless device is configured to communicate, using a set of beams, with a network node of a wireless communication system. A beam may be seen as a spatial filter. An antenna circuitry of the network node may be configured to radiate a set of beams associated with a set of direction. An antenna circuitry of the wireless device may be configured to radiate a set of beams associated with a set of direction.

The method 100 comprises determining S104 an inability to establish beam correspondence. Stated differently, the wireless device determines that beam correspondence cannot be established. For example, when the wireless device switches on, the wireless device may measure noise. For example, an inability of establishing a beam correspondence may be seen as, for example, the wireless device not able to autonomously select a suitable UL beam based on DL measurement on the DL beam (see TS38.306, TS38,101 v15.5.0).

For example, the wireless device cannot achieve beam correspondence because the wireless device is not able to select a suitable UL beam based on DL measurements on a DL beam or to select a suitable DL beam based on UL measurements on an UL beam due to channel conditions and/or hardware configurations of the wireless device.

The method 100 comprises transmitting S108, in response to the determining S104, control signaling indicative of a need for altering DL beam reference signaling for beam correspondence. For example, a need for altering DL beam reference signaling for beam correspondence may be seen as an indicator that alteration of beam reference signaling is needed at the wireless device so that the wireless device can autonomously select the suitable UL beam. A need may comprise a requested alteration, such as a requested modification. Stated differently, the control signaling may be indicative of a request for altering the DL beam reference signaling so that the wireless device is able to obtain beam correspondence autonomously. For example, altering DL beam reference signaling may comprise DL beam reference signaling enhancing. For example, altering DL beam reference signaling may comprise degrading DL beam reference signaling. The network node altering DL beam reference signaling may help the wireless device in selecting the UL beam based on the DL measurements.

For example, in response to determining an inability to establish beam correspondence, the wireless device may transmit a control signaling to the network node that indicates (indicative of) that the wireless device needs an altered DL beam reference signaling (such as more DL RS resources) in order to autonomously select the uplink beam (to obtain beam correspondence) when the DL SNR or SINR is below a first threshold.

In one or more example methods, the method 100 may comprise obtaining information about the current reference signaling from a network node (e.g. by receiving information in a System Information Block (SIB) about the current reference signaling, or by retrieving a default pre-configured value of the current reference signaling). In one or more example methods, the method may comprise measuring the noise and interference level. In one or more example methods, the method may comprise determining, optionally based on obtaining information and measuring, whether or not beam correspondence is established.

In one or more example methods, the method 100 may comprise receiving S102 one or more downlink, DL, beam reference signals from the network node. In one or more example methods, receiving S102 the one or more downlink, DL, beam reference signals from the network node may comprise receiving S102A, over one or more beams, one or more downlink, DL, beam reference signals from the network node. For example, one or more downlink beam reference signals may comprise one or more spatial filters.

In one or more example methods, determining S104 the inability comprises determining S104A, based on the one or more received DL beam reference signals, one or more DL reception quality parameters associated with an ability of establishing a beam correspondence. The one or more DL reception quality parameters may be indicative of the radio or channel conditions and/or indicative of hardware noise. The one or more DL reception quality parameters may comprise SNR signal-to-noise-ratio, and/or SINR signal-to-interference -and-noise-ratio. The DL reception quality parameter may comprise a noise parameter (e.g. SNR), an interference parameter (e.g. SINR), a RSRP parameter, and/or a received signal strength parameter.

In one or more example methods, the method 100 comprises determining S106 whether the one or more DL reception quality parameters satisfy the quality criterion.

In one or more example methods, the method 100 comprises transmitting S108 the control signaling upon determination of the one or more DL reception quality parameters not satisfying a quality criterion.

In one or more example methods, the method 100 comprises forgoing S107 the transmission of the control signaling upon determination of the one or more DL reception quality parameters satisfying a quality criterion.

In one or more example methods, the quality criterion may be based on a set of thresholds. For example, the wireless device may transmit a control signaling upon determination of the one or more DL reception quality parameters not satisfying a quality criterion, which may be based on a first threshold. Further, a control signaling may be transmitted by the wireless device to the network node to perform an uplink beam sweeping, when the DL SNR or SINR is below a second threshold, where the second threshold of SNR or SINR may be lower than the first threshold.

For example, the transmission of the control signaling may also be triggered after the network node has altered the DL beam reference signaling.

For example, the wireless device may selectively transmit the control signaling based on a channel condition. For a noise-limited channel, the wireless device may request for an enhanced DL RS.

In one or more example methods, the control signaling indicative of the need for altering DL beam reference signaling comprises control signaling indicative of a need for an additional downlink, DL, resource for beam reference signaling. For example, an additional DL resource may refer to an additional resource in time, and/or resource in frequency. For example, an additional DL resource may refer to a higher number in subcarrier in OFDM symbols, and/or more SRS resources.

In one or more example methods, the control signaling indicative of the need for altering DL beam reference signaling comprises control signaling indicative of a need for a modified power of the one or more DL beam reference signals.

In one or more example methods, the control signaling indicative of the need for altering DL beam reference signaling comprises control signaling indicative of a need for a modified periodicity of reception of the one or more DL beam reference signals.

For example, a modified periodicity may comprise a more frequently transmitted CSI-RS. In one or more example methods, the control signaling indicative of the need for altering DL beam reference signaling comprises control signaling indicative of a modified signal strength.

In one or more example methods, the control signaling indicative of the need for altering DL beam reference signaling comprises a request for an amount of increase and/or decrease in resources allocated.

In one or more example methods, the control signaling indicative of the need for altering DL beam reference signaling comprises one or more DL reception quality parameters associated with the ability of establishing a beam correspondence. For example, the ability may be seen as the present ability of the wireless device, for example of achieving beam correspondence.

In one or more example methods, the control signaling indicative of the need for altering DL beam reference signaling may comprise control signaling indicative of a need for uplink beam sweeping.

In one or more example methods, the DL beam reference signaling may comprise a set of alteration levels. For example, the control signaling indicative of the need for altering DL beam reference signaling may comprise control signaling indicative of an alteration level (such as an alteration level needed by the wireless device). An alteration level corresponds to an alteration technique, for example one or more of: modification of transmit power of DL beam reference signals, modification of resource allocation for the DL beam reference signals, modification of periodicity of the DL beam reference signals, etc.

In one or more example methods, techniques described in relation to DL beam reference signals may be applied to UL beam reference signals in that a DL beam may be selected based on based the network node's indication of uplink measurement on UE's one or more UL/Tx beams.

In one or more example methods, the set of alteration levels may comprise one or more alteration levels ordered according to an order. For example, alteration levels may be ordered based on power consumption of the alterations, and/or on the interference level of the alterations (e.g. not to cause interference to neighbouring cells).

In one or more example methods, the one or more DL reception quality parameters associated with the ability of establishing a beam correspondence may comprise one or more of: a parameter indicative of a signal to noise ratio, a parameter indicative of a signal to noise plus interference ratio, a parameter indicative of received power, and a parameter indicative of radiated power.

In one or more example methods, the method 100 comprises receiving S109 control signaling indicative of altered DL beam reference signaling.

In one or more example methods, the method 100 comprises receiving S110 one or more DL beam reference signals altered by one or more of: an increased transmit power, an additional resource, and an increased periodicity of transmission.

In one or more example methods, the method 100 comprises obtaining S112 beam correspondence. Obtaining S112 beam correspondence may comprise selecting autonomously an UL beam based on DL measurements on a DL beam and/or selecting autonomously a DL beam based the network node's indication of uplink measurement on UE's one or more Tx beams. Obtaining S112 BC may comprise achieving and/or sustaining BC.

FIG. 4 is a block diagram illustrating an exemplary wireless device 300 according to this disclosure.

The wireless device 300 comprises a memory circuitry 301, a processor circuitry 302, and a wireless interface 303. The wireless device 300 is configured to perform any of the methods disclosed in FIG. 3.

The wireless device 300 is configured to communicate with a network node, such as the network node 400 disclosed herein, using a wireless communication system (as illustrated in FIG. 1A).

The wireless interface 303 is configured for wireless communications via a wireless communication system, such as a 3GPP system, such as a 3GPP system supporting beam reference signaling. The wireless interface 303 may comprise an antenna array 303A comprising a plurality of antenna array elements.

The wireless device 300 is configured to communicate (via the wireless interface 303), using a set of beams, with a network node of a wireless communication system.

The wireless device 300 is configured to determine (for example using the processor circuitry 302) an inability to establish beam correspondence.

The wireless device 300 is configured to transmit to the network node (for example using the wireless interface 303), in response to the determining, control signaling indicative of a need for altering DL beam reference signaling for beam correspondence.

The processor circuitry 302 is optionally configured to perform any of the steps or operations disclosed in FIG. 3 (for example, S102, S102A, S104, S104A, S106, S107, S108, S109, S110, S112). The operations of the wireless device 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the wireless device 300 may be considered a method that the wireless circuitry is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 4). The memory circuitry 301 is considered a non-transitory computer readable medium.

The memory circuitry 301 may be configured to a set of alteration levels in a part of the memory circuitry 301.

FIG. 5 is a block diagram illustrating an exemplary network node 400 according to this disclosure.

The network node comprises a memory circuitry 401, a processor circuitry 402, and a wireless interface 403. The network node 400 is configured to perform any of the methods disclosed in FIG. 2.

The network node 400 is configured to communicate with a wireless device and a network, such as the wireless device 300 disclosed herein, using a wireless communication system (as illustrated in FIG. 1A).

The wireless interface 403 is configured for wireless communications via a wireless communication system, such as a 3GPP system, such as a 3GPP system supporting beam reference signaling.

The wireless interface 403 may comprise an antenna array 403A comprising a plurality of antenna array elements. The network node 400 is optionally configured to communicate (via the wireless interface 403), using a set of beams (e.g. radiated by 403A), with a wireless device. The network node 400 is optionally configured to communicate (via the wireless interface 403), using an omnidirectional antenna with a wireless device.

The network node 400 is configured to transmit (for example via the wireless interface 403) one or more first downlink, DL, beam reference signals to the wireless device. The network node 400 is configured to receive (for example using the wireless interface 403), from the wireless device, control signaling indicative of a need for altering downlink beam reference signaling (e.g. to obtain beam correspondence autonomously).

The processor circuitry 402 is optionally configured to perform any of the operations disclosed in FIG. 2 (for example S202A, S202B, S204, S205, S206, S208). The operations of the network node 400 may be embodied in the form of executable logic routines (e.g., lines of code, software programs, etc.) that are stored on a non-transitory computer readable medium (e.g., the memory circuitry 401) and are executed by the processor circuitry 402).

Furthermore, the operations of the network node 400 may be considered a method that the wireless circuitry is configured to carry out. Also, while the described functions and operations may be implemented in software, such functionality may as well be carried out via dedicated hardware or firmware, or some combination of hardware, firmware and/or software.

The memory circuitry 401 may be one or more of a buffer, a flash memory, a hard drive, a removable media, a volatile memory, a non-volatile memory, a random access memory (RAM), or other suitable device. In a typical arrangement, the memory circuitry 401 may include a non-volatile memory for long term data storage and a volatile memory that functions as system memory for the processor circuitry 402. The memory circuitry 401 may exchange data with the processor circuitry 402 over a data bus. Control lines and an address bus between the memory circuitry 401 and the processor circuitry 402 also may be present (not shown in FIG. 5). The memory circuitry 401 is considered a non-transitory computer readable medium.

The memory circuitry 401 may be configured to store a set of alteration levels in a part of the memory.

Embodiments of methods and products (network node and wireless device) according to the disclosure are set out in the following items:

Item 1. A method, performed by a network node, for beam reference signaling, wherein the network node is configured to communicate with a wireless device of a wireless communication system, the method comprising:
transmitting (S202) one or more first downlink, DL, beam reference signals to the wireless device; and
receiving (S204), from the wireless device, control signaling indicative of a need for altering downlink beam reference signaling.

Item 2. The method according to item 1, the method comprising: upon one or more criterion being fulfilled:
transmitting (S206), based on the received control signaling, one or more second DL beam reference signals to the wireless device, wherein the one or more second DL beam reference signals differ from the one or more first DL beam reference signals.

Item 3. The method according to any of items 1-2, the method comprising: transmitting (S205) control signaling indicative of altered DL beam reference signaling.

Item 4. The method according to any of items 1-3, wherein the control signaling indicative of a need for altering downlink beam reference signaling comprises control signaling indicative of a need for an additional downlink, DL, resource for beam reference signaling.

Item 5. The method according to any of items 1-4, wherein the control signaling indicative of the need for altering downlink beam reference signaling comprises control signaling indicative of a need for a modified power of the one or more DL beam reference signals.

Item 6. The method according to any of items 1-5, wherein the control signaling indicative of the need for altering downlink beam reference signaling comprises control signaling indicative of a need for a modified periodicity of transmission of the one or more DL beam reference signals.

Item 7. The method according to any of items 1-6, wherein the control signaling indicative of the need for altering downlink beam reference signaling comprises control signaling indicative of a need for uplink beam sweeping, the method comprising requesting the wireless device to perform uplink beam sweeping.

Item 8. The method according to any of items 1-7, wherein transmitting (S202) one or more first DL beam reference signals to the wireless device comprises transmitting (S202A), on one or more receive beams, the one or more first DL beam reference signals to the wireless device.

Item 9. The method according to any of items 1-8, wherein transmitting (S202) one or more first DL beam reference signals to the wireless device comprises broadcasting (S202B), the one or more first DL beam reference signals.

Item 10. The method according to any of items 2-9, wherein the one or more second DL beam reference signals comprise one or more second DL beam reference signals with one or more of: a modified transmit power, an additional resource allocated, and a modified periodicity of transmission.

Item 11. A method, performed by a wireless device, for beam reference signaling, wherein the wireless device is configured to communicate, using a set of beams, with a network node of a wireless communication system, the method comprising:
determining (S104) an inability to establish beam correspondence; and
transmitting (S108) to the network node, in response to the determining (S104), control signaling indicative of a need for altering DL beam reference signaling for beam correspondence.

Item 12. The method according to item 11, the method comprising:
receiving (S102) one or more downlink, DL, beam reference signals from the network node; and
   wherein the determining (S104) the inability comprises
determining (S104A), based on the one or more received DL beam reference signals, one or more DL reception quality parameters associated with an ability of establishing a beam correspondence; and
transmitting (S108) the control signaling upon determination of the one or more DL reception quality parameters not satisfying a quality criterion.

Item 13. The method according to any of items 11-12, the method comprising: determining (S106) whether the one or more DL reception quality parameters satisfy the quality criterion.

Item 14. The method according to any of items 12-13, wherein the quality criterion is based on a set of thresholds.

Item 15. The method according to any of items 11-14, wherein the control signaling indicative of the need for altering DL beam reference signaling comprises control signaling indicative of a need for an additional downlink, DL, resource for beam reference signaling.

Item 16. The method according to any of items 11-15, wherein the control signaling indicative of the need for altering DL beam reference signaling comprises control signaling indicative of a need for a modified power of the one or more DL beam reference signals.

Item 17. The method according to any of items 11-16, wherein the control signaling indicative of the need for altering DL beam reference signaling comprises control signaling indicative of a need for a modified periodicity of reception of the one or more DL beam reference signals.

Item 18. The method according to any of items 11-17, wherein the control signaling indicative of the need for altering DL beam reference signaling comprises one or more DL reception quality parameters associated with the ability of establishing a beam correspondence.

Item 19. The method according to any of items 11-18, wherein the control signaling indicative of the need for altering DL beam reference signaling comprises control signaling indicative of a need for uplink beam sweeping.

Item 20. The method according to any of items 11-19, wherein the DL beam reference signaling comprises a set of alteration levels.

Item 21. The method according to item 20, wherein the set of alteration levels comprises one or more alteration levels ordered according to an order.

Item 22. The method according to any of items 12-21, wherein the one or more DL reception quality parameters associated with the ability of establishing a beam correspondence comprise one or more of: a parameter indicative of a signal to noise ratio, a parameter indicative of a signal to noise plus interference ratio, a parameter indicative of received power, and a parameter indicative of radiated power.

Item 23. The method according to any of items 11-22, the method comprising:
receiving (S110) one or more DL beam reference signals altered by one or more of: an increased transmit power, an additional resource, and an increased periodicity of transmission; and
obtaining (S112) beam correspondence.

Item 24. The method according to any of items 11-23, the method comprising: receiving (S109) control signaling indicative of altered DL beam reference signaling.

Item 25. A wireless device (300) comprising a memory circuitry (301), a processor circuitry (302), and a wireless interface (303), wherein the wireless device (300) is configured to perform any of the methods according to any of items 11-24.

Item 26. A network node (400) comprising a memory circuitry (401), a processor circuitry (402), and an interface (403), wherein the network node (400) is configured to perform any of the methods according to any of items 1-10.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1A-5 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a network node, for beam reference signaling, wherein the network node is configured to communicate with a wireless device of a wireless communication system, the method comprising:
transmitting one or more first downlink, DL, beam reference signals to the wireless device; and
receiving, from the wireless device, control signaling indicative of a need for altering downlink beam reference signaling.

2. The method according to claim 1, the method comprising: upon one or more criterion being fulfilled:
transmitting, based on the received control signaling, one or more second DL beam reference signals to the wireless device, wherein the one or more second DL beam reference signals differ from the one or more first DL beam reference signals.

3. The method according to claim 1, the method comprising: transmitting control signaling indicative of altered DL beam reference signaling.

4. The method according to claim 1, wherein the control signaling indicative of a need for altering downlink beam reference signaling comprises at least one of: control signaling indicative of a need for an additional downlink, DL, resource for beam reference signaling, control signaling indicative of a need for a modified power of the one or more DL beam reference signals, and control signaling indicative of a need for a modified periodicity of transmission of the one or more DL beam reference signals.

5. The method according to claim 1, wherein the control signaling indicative of the need for altering downlink beam reference signaling comprises control signaling indicative of a need for uplink beam sweeping, the method comprising requesting the wireless device to perform uplink beam sweeping.

6. The method according to claim 1, wherein transmitting one or more first DL beam reference signals to the wireless device comprises transmitting, on one or more receive beams, the one or more first DL beam reference signals to the wireless device.

7. The method according to claim 1, wherein transmitting one or more first DL beam reference signals to the wireless device comprises broadcasting, the one or more first DL beam reference signals.

8. The method according to claim 2, wherein the one or more second DL beam reference signals comprise one or more second DL beam reference signals with one or more of: a modified transmit power, an additional resource allocated, and a modified periodicity of transmission.

9. A method, performed by a wireless device, for beam reference signaling, wherein the wireless device is configured to communicate, using a set of beams, with a network node of a wireless communication system, the method comprising:
determining an inability to establish beam correspondence; and
transmitting to the network node, in response to the determining, control signaling indicative of a need for altering DL beam reference signaling for beam correspondence.

10. The method according to claim 9, the method comprising:
receiving one or more downlink, DL, beam reference signals from the network node; and
wherein the determining the inability comprises
determining, based on the one or more received DL beam reference signals, one or more DL reception quality parameters associated with an ability of establishing a beam correspondence; and
transmitting the control signaling upon determination of the one or more DL reception quality parameters not satisfying a quality criterion.

11. The method according to claim 9, the method comprising: determining whether the one or more DL reception quality parameters satisfy the quality criterion.

12. The method according to claim 9, wherein the control signaling indicative of the need for altering DL beam reference signaling comprises at least one of: control signaling indicative of a need for an additional downlink, DL, resource for beam reference signaling, control signaling indicative of a need for a modified power of the one or more DL beam reference signals, and control signaling indicative of a need for a modified periodicity of reception of the one or more DL beam reference signals.

13. The method according to claim 9, wherein the DL beam reference signaling comprises a set of alteration levels.

14. The method according to claim 9, wherein the one or more DL reception quality parameters associated with the ability of establishing a beam correspondence comprise one or more of: a parameter indicative of a signal to noise ratio, a parameter indicative of a signal to noise plus interference ratio, a parameter indicative of received power, and a parameter indicative of radiated power.

15. The method according to claim 9, the method comprising:
receiving one or more DL beam reference signals altered by one or more of: an increased transmit power, an additional resource, and an increased periodicity of transmission; and
establishing beam correspondence.
